(19) United States
(12) Patent Application Publication
(10) Pub. No.: US 2010/0014317 A1
(43) Pub. Date: Jan. 21, 2010

(54) LIGHT GUIDE PLATE AND BACKLIGHT MODULE USING THE SAME

(75) Inventor: MING-YI LIAO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/327,654

(22) Filed: Dec. 3, 2008

(30) Foreign Application Priority Data
Jul. 18, 2008 (CN) 200810302797.5

(51) Int. Cl. F21V 7/09; G02B 5/09; F21V 8/00; F21V 5/00

(52) U.S. Cl. 362/619; 359/851; 362/625

(57) ABSTRACT

An exemplary light guide plate includes a light input surface, a light output surface adjoining the light input surface, and a reflecting surface opposite the light output surface. At least one of the light output surface and the reflecting surface defines a plurality of microstructures extending along a direction from a first side away from the light input surface to the light input surface, and the extending paths of the plurality of microstructures gradually transform from parallel straight lines to intersecting curves.

### BACKGROUND

1. Technical Field

The present disclosure relates to a light guide plate for use in a backlight module.

2. Description of Related Art

In a typical liquid crystal display device, a liquid crystal panel of the typical liquid crystal display device relies on a backlight module powered by electricity to supply the light needed to display images and data.

Currently, backlight modules can be classified as either an edge lighting type or a bottom lighting type depending upon the location of lamps within the device. A typical edge lighting type backlight module includes a light source and a light guide plate. The light guide plate includes a light input surface located at a side surface thereof, a light output surface adjoining the light input surface, and a reflecting surface positioned opposite the light output surface. The light source is generally positioned at the light input surface of the light guide plate. The light guide plate may have a plurality of V-shaped prism lenses arranged on the light output surface and extending along a direction perpendicular to the light input surface. Light is emitted out the V-shaped prism lenses at a relatively small light emitting angle, thereby condensing the light and increasing the backlight module's optical brightness.

However, the brightness of the edge lighting type backlight module is not uniform because an area of the light output surface adjacent the light source has a high brightness, and an area of the light output surface away from the light source has a low brightness. In addition, interference lines, such as a plurality of dark and bright lines, are unavoidably formed on the light output surface adjacent the light source because the configuration of the V-shaped prism lenses are regular, periodic extend along a same direction.

What is needed, therefore, is a new light guide plate and a backlight module that overcomes the above mentioned disadvantages.

### BRIEF DESCRIPTION OF THE DRAWINGS

The components in the drawings are not necessarily drawn to scale, the emphasis instead being placed upon clearly illustrating the principles of the present light guide plate and backlight module. Moreover, in the drawings, like reference numerals designate corresponding parts throughout the several views, and all the views are schematic.

FIG. 1 is an isometric view of a first embodiment of a backlight module, the backlight module including a light guide plate.

FIG. 2 is a schematic, isometric view of the light guide plate in FIG. 1.

FIG. 3 is a partial, cross-sectional view of the light guide plate taken along line III-III in FIG. 2.

FIG. 4 is a top view of the light guide plate in FIG. 2.

FIG. 5 is a partial, enlarged view of extending paths of the plurality of microstructures of the light guide plate in FIG. 2.

FIG. 6 is a partial, enlarged view of extending paths of the plurality of microstructures of a light guide plate according to a second embodiment.

FIG. 7 is a partial, cross-sectional view of a light guide plate according to a third embodiment.

FIG. 8 is a partial, cross-sectional view of a light guide plate according to a fourth embodiment.

FIG. 9 is a partial, cross-sectional view of a light guide plate according to a fifth embodiment.

### DETAILED DESCRIPTION OF THE EMBODIMENTS

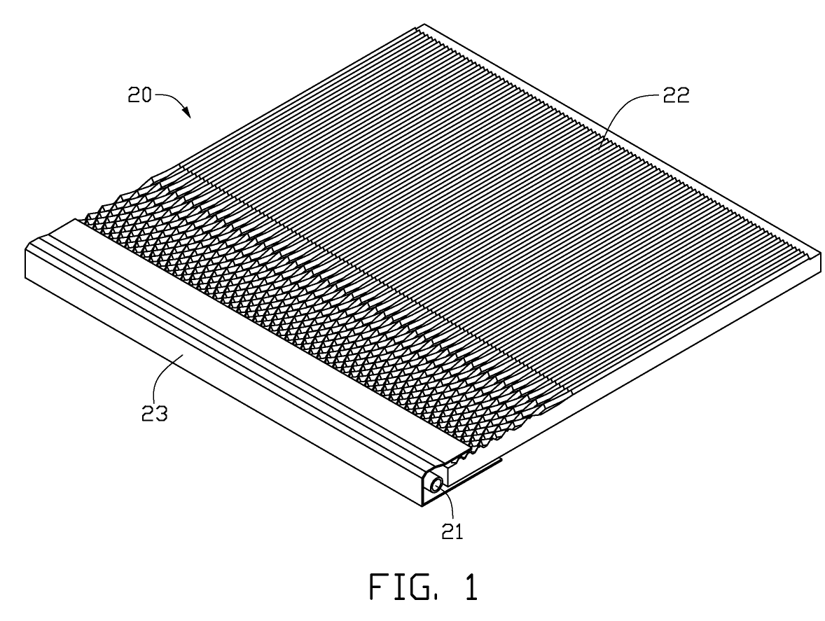

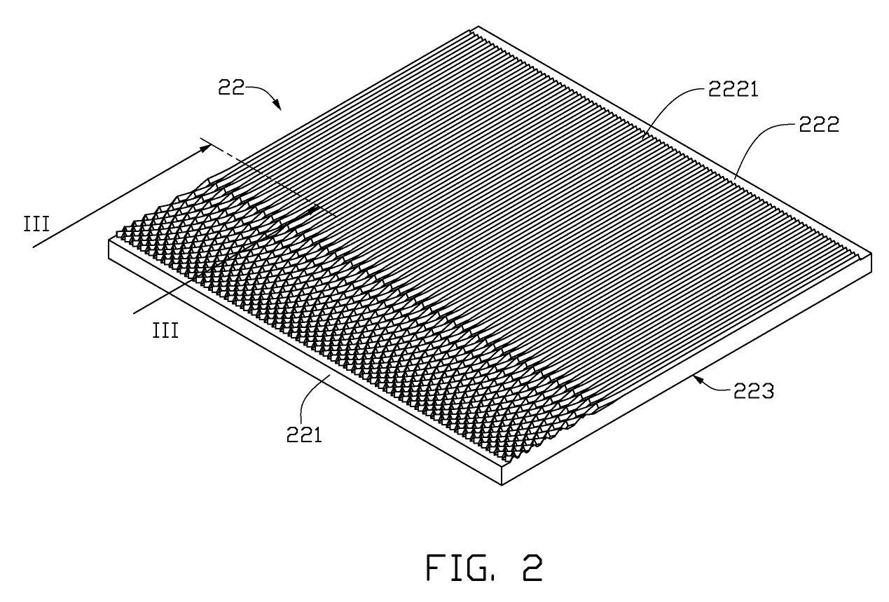

Referring to FIGS. 1 and 2, a backlight module 20 in accordance with a first embodiment is shown. The backlight module 20 includes a light source 21, a light guide plate 22, and a reflector 23. In the illustrated embodiment, the light source 21 may be a cold cathode fluorescent lamp. In another embodiment, the light source 21 may be a plurality of light emitting diodes arranged in a straight line. The light guide plate 22 is a transparent plate, and includes a light input surface 221 located at a first side of the light guide plate 22, a light output surface 222 adjoining the light input surface 221, and a reflecting surface 223 opposite the light output surface 222. In one embodiment, the reflecting surface 223 may be a foggy surface or include a plurality of scattering elements positioned on the reflecting surface 223, to create a light scattering effect to improve the uniform optical performance of the light guide plate 22. The light source 21 is positioned at the light input surface 221 of the light guide plate 22. The light guide plate 22 includes a plurality of elongated V-shaped protrusions 2221 formed on the light output surface 222. The reflector 23 partially surrounds the light source 21 away from the light guide plate 22 to improve light energy utilization rate. In one embodiment, a high reflectivity film may be deposited on inner surface of the reflector 23 for improving reflective effect.

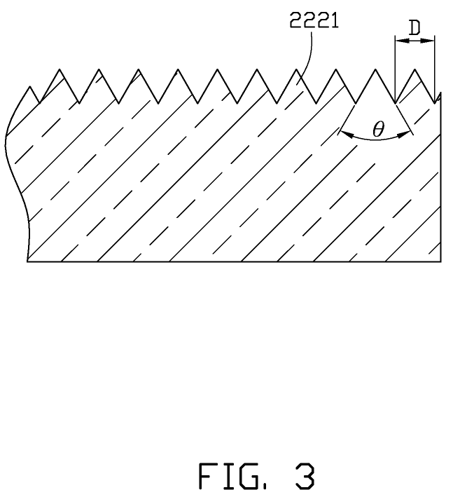

Referring to FIG. 3, in the illustrated embodiment, the elongated V-shaped protrusions 2221 are positioned on the light output surface 222 in such a manner that the elongated V-shaped protrusions 2221 are connected with each other. A vertex angle θ of each elongated V-shaped protrusion 2221 is less than or equal to 175 degrees. A maximum width D of each elongated V-shaped protrusion 2221 is less than or equal to 1 millimeter. In another embodiment, the elongated V-shaped protrusions 2221 may be formed on the reflecting surface 223, or formed on both the light output surface 222 and the reflecting surface 223.

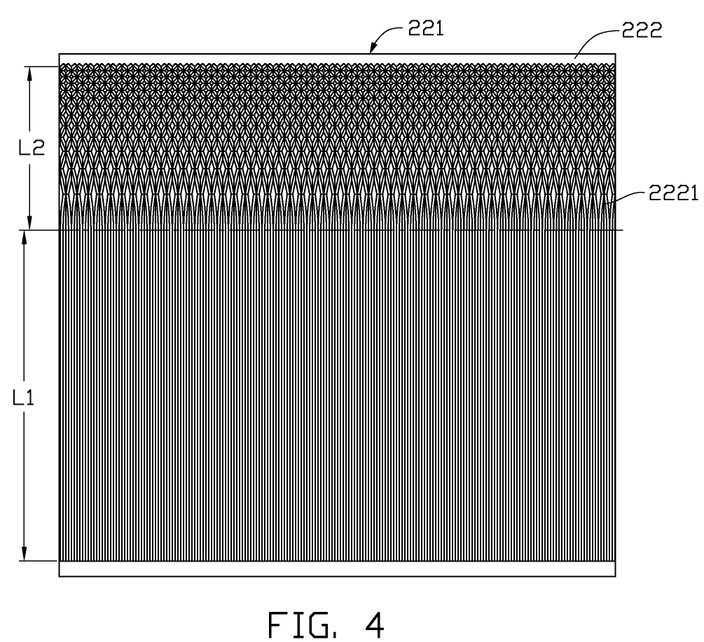

Referring to FIG. 4, the elongated V-shaped protrusions 2221 extend along a direction from a second side away from the light input surface 221 to the first side adjacent the light input surface 221. The extending paths of the elongated V-shaped protrusions 2221 gradually transform from parallel straight lines to intersecting curves. A radius of curvature of each elongated V-shaped protrusion 2221 extending along the curve increases with increasing distance from the light input surface 221. Thus, the closer the elongated V-shaped protrusions 2221 are to the light input surface 221, the greater the frequency of intersecting points of the elongated V-shaped protrusions 2221 occur on the light output surface 222.

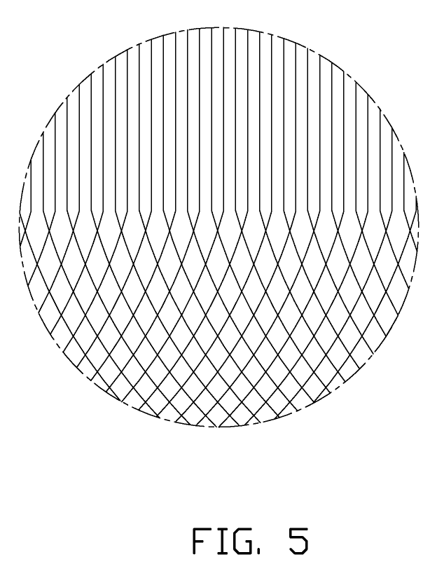

Referring to FIG. 5, extending paths of the plurality of elongated V-shaped protrusions 2221 are shown. Every other elongated V-shaped protrusion 2221 follows an extending path having a same curve, and every adjacent elongated V-shaped protrusion 2221 follows an extending path having a symmetrically opposite curve. Thus, the elongated V-shaped protrusions 2221 extending along the curves are interwoven with each other.

Referring to FIG. 4 again, the elongated V-shaped protrusions 2221 extend along the curves from a same position on the light output surface 222, such that each of the elongated V-shaped protrusions 2221 extending along the straight lines have the same length. In the illustrated embodiment, a length L1 of the portion of the elongated V-shaped protrusions 2221 extending along the straight line is longer than a length L2 of the portion of the elongated V-shaped protrusions 2221 extending along the curves. The value of the length L2 is determined by a certain minimum distance from the first side, such that interference lines are minimized to an acceptable level.

In alternative embodiments, the elongated V-shaped protrusions 2221 may extend along the curves from different positions, such that the elongated V-shaped protrusions 2221 extending along the straight lines may have different lengths.

The light guide plate 22 may be made from a material such as polycarbonate (PC), polymethyl methacrylate (PMMA), polystyrene (PS), copolymer of methylmethacrylate and styrene (MS), and any suitable combination thereof. The elongated V-shaped protrusions 2221 may be integrally manufactured with the light guide plate 22 such as injection molding, finish machining, or other suitable technology.

Referring to FIGS. 1 and 2 again, light is projected from the light source 21 to the light input surface 221 of the light guide plate 22. The elongated V-shaped protrusions 2221 extend along the intersecting curves on the light output surface 222 adjacent the light source 21. Accordingly, the light is scattered sufficiently to avoid high brightness areas. In addition, some light is reflected and refracted at each elongated V-shaped protrusion 2221, the intensity of the light emitted at different portions of each elongated V-shaped protrusion is different, thus decreasing the occurrences of interference lines on the light output surface 222 adjacent the light source 21. Moreover, the elongated V-shaped protrusions 2221 extend along parallel straight lines on the light output surface 222 away from the light source 21. Accordingly, the light is polarized to a direction perpendicular to the light input surface 221. During the light transmission process, the light becomes condensed, thereby improving a light illumination brightness of an area on the light output surface 222 away from the light source 21. Thus, not only does the present light guide plate 22 efficiently decreases interference, but also improves the optical uniformity.

In alternative embodiments, the elongated V-shaped protrusions 2221 may be distributed on the light output surface 222 in such a manner that the elongated V-shaped protrusions 2221 are spaced from each other. The elongated V-shaped protrusions 2221 extending along the straight lines may be substantially perpendicular to the light input surface 221.

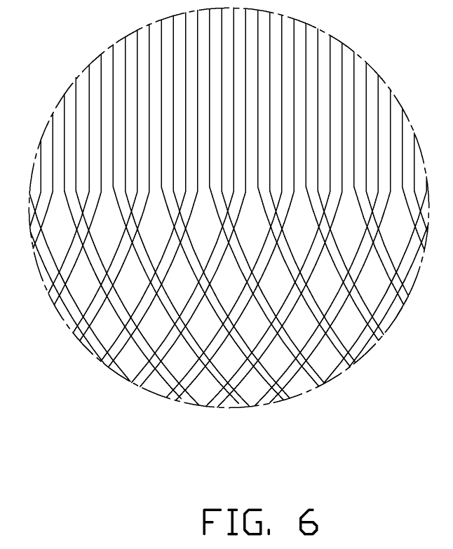

Referring to FIG. 6, extending paths of a plurality of elongated V-shaped protrusions of a light guide plate according to a second embodiment are shown. The second embodiment of the light guide plate is similar to the first embodiment of the light guide plate 22, except that each pair of adjacent elongated V-shaped protrusions are defined as a group, and the elongated V-shaped protrusions in one group follow an extending path having the same first curve. Every adjacent group of elongated V-shaped protrusions follows an extending path having a curve symmetrically opposite to the first curve. Thus, the elongated V-shaped protrusions extending along the curves are interwoven with each other. In an alternative embodiment, each three, four, or other desired number of adjacent elongated V-shaped protrusions may be defined as a group.

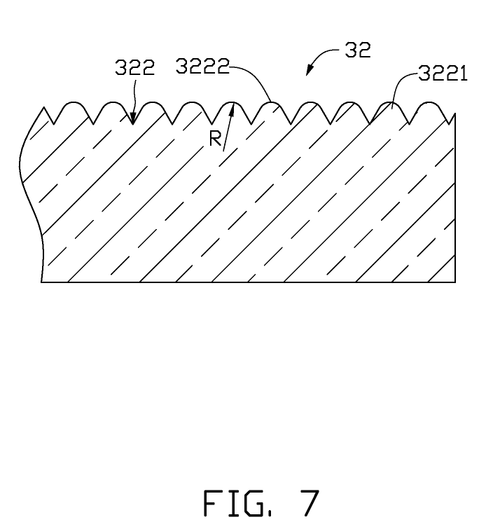

Referring to FIG. 7, a third embodiment of a light guide plate 32 is similar to the first embodiment of the light guide plate 22 except that the light guide plate 32 includes a plurality of elongated V-shaped protrusions 3221 positioned on a light output surface 322, and a vertex of each elongated V-shaped protrusion 3221 is rounded thus forming a curved surface 3222. A radius R of the curved surface 3222 is less than or equal to 2 millimeters.

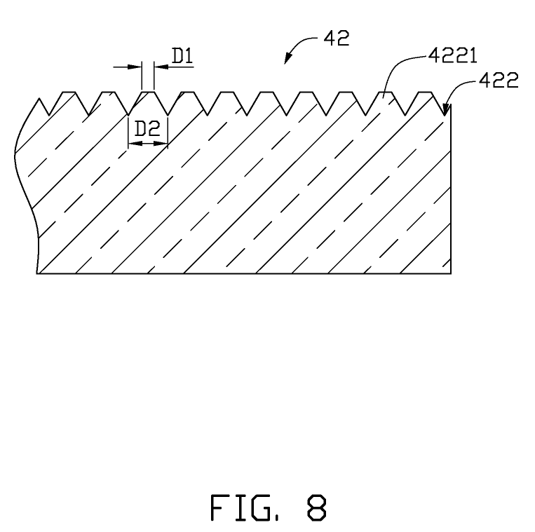

Referring to FIG. 8, a fourth embodiment of a light guide plate 42 is similar to the first embodiment of the light guide plate 22 except that the light guide plate 42 includes a plurality of elongated trapezoidal protrusions 4221 positioned on a light output surface 422. A width D1 of the top surface of each elongated trapezoidal protrusion 4221 and a width D2 of the bottom surface of the elongated trapezoidal protrusion 4221 are both less than or equal to 1 millimeter. In addition, the width D1 of the top surface is smaller than the width D2 of the bottom surface.

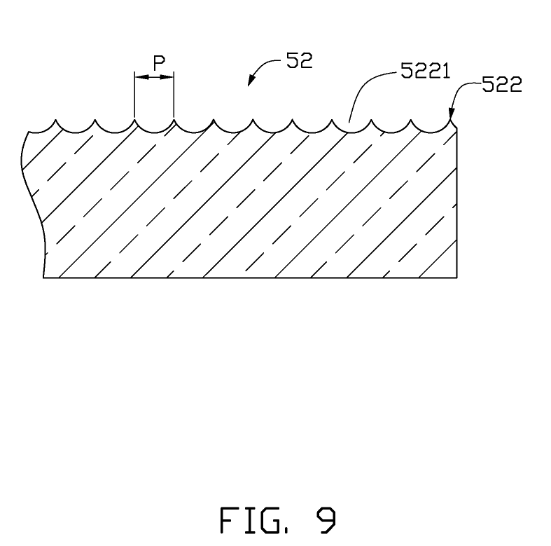

Referring to FIG. 9, a fifth embodiment of a light guide plate 52 is similar to the first embodiment of the light guide plate 22 except that the light guide plate 52 includes a plurality of elongated arched depressions 5221 defined in a light output surface 522. A maximum width P of each elongated arched depressions 5221 is less than or equal to 1 millimeter.

In alternative embodiments, the plurality of the elongated V-shaped protrusions 2221, 3221 may be a plurality of elongated V-shaped depressions. The plurality of elongated trapezoidal protrusions 4221 may be a plurality of elongated trapezoidal depressions. The plurality of elongated arched depressions 5221 may be a plurality of the elongated arched protrusions. The elongated V-shaped protrusions 2221, 3221, the elongated trapezoidal protrusions 4221 and the elongated arched depressions 5221 may be substituted with other microstructures.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A light guide plate, comprising:
a light input surface;
a light output surface adjoining the light input surface; and
a reflecting surface opposite to the light output surface;
wherein at least one of the light output surface and the reflecting surface defines a plurality of microstructures extending along a direction from a first side away from the light input surface to the light input surface, and the extending paths of the plurality of microstructures gradually transform from parallel straight lines to intersecting curves.

2. The light guide plate of claim 1, wherein the plurality of microstructures is a plurality of elongated V-shaped protrusions.

3. The light guide plate of claim 2, wherein a vertex angle of each elongated V-shaped protrusion is less than or equal to 175 degrees, and a maximum width of each elongated V-shaped protrusion is less than or equal to 1 millimeter.

4. The light guide plate of claim 1, wherein a radius of curvature of each micro-structure extending along the curve increases with increasing distance from the light input surface.

5. The light guide plate of claim 1, wherein each set of the plurality of microstructures comprises a first microstructure following an extending path having a first curve, and an adjacent second microstructure following an extending path having a second curve symmetrically opposite to the first curve.

6. The light guide plate of claim 1, wherein the plurality of microstructures extends along the curves from a similar position on the light guide plate, and the plurality of microstructures extending along straight lines have a same length.

7. The light guide plate of claim 6, wherein a length of a portion of the microstructures extending along the straight lines is longer than a length of a portion of the microstructures extending along the curves.

8. The light guide plate of claim 1, wherein each pair of adjacent microstructures are defined as a group, the microstructures in one group following an extending path having a first curve, and every adjacent group of elongated V-shaped protrusions follows an extending path having a second curve symmetrically opposite to the first curve.

9. The light guide plate of claim 1, wherein the plurality of microstructures is a plurality of elongated V-shaped protrusions, and a vertex of each elongated V-shaped protrusion is rounded thereby forming a curved surface.

10. The light guide plate of claim 9, wherein a radius of the curved surface is less than or equal to or smaller than 2 millimeters.

11. The light guide plate of claim 1, wherein the plurality of microstructures is a plurality of elongated trapezoidal protrusions.

12. The light guide plate of claim 11, wherein a width of the top surface of the elongated trapezoidal protrusion and a width of the bottom surface of the elongated trapezoidal protrusion are both less than or equal to 1 millimeter, and the width of the top surface is less than the width of the bottom surface.

13. The light guide plate of claim 1, wherein the plurality of microstructures is a plurality of elongated arched depressions.

14. The light guide plate of claim 13, wherein a maximum width of each elongated arched depression is less than or equal to 1 millimeter.

15. The light guide plate of claim 1, wherein the light guide plate is made from a material selected from the group consisting of polycarbonate, polymethyl methacrylate, polystyrene, copolymer of methylmethacrylate and styrene, and any combination thereof.

16. A backlight module comprising:
a light source; and
a light guide plate comprising
a light input surface, the light source disposed adjacent to the light input surface;
a light output surface adjoining the light input surface, and
a reflecting surface opposite the light output surface;
wherein at least one of the light output surface and the reflecting surface defines a plurality of microstructures extending along a direction from a first side away from the light input surface to the light input surface, and the extending paths of the plurality of microstructures gradually transform from parallel straight lines to intersecting curves.

17. The backlight module of claim 16, wherein the light source is a cold cathode fluorescent lamp, or a plurality of light emitting diodes.

18. The backlight module of claim 16, further comprising a reflector partially surrounding the light source away from the light guide plate, and a high reflectivity film is deposited on an inner surface of the reflector.
